(19) United States
(12) Patent Application Publication
(10) Pub. No.: US 2011/0292941 A1
(43) Pub. Date: Dec. 1, 2011

(54) TRANSMITTER AND CONTROL INFORMATION CONFIGURATION METHOD

(75) Inventors: Koichi YATSU, Kawasaki (JP); Eiji Sugawara, Kawasaki (JP)

(73) Assignee: FUJITSU LIMITED, Kawasaki-shi (JP)

(21) Appl. No.: 13/105,677

(22) Filed: May 11, 2011

(30) Foreign Application Priority Data
May 26, 2010 (JP) 2010-120997

(51) Int. Cl. H04L 12/28

(52) U.S. Cl. 370/392

(57) ABSTRACT

A transmitter includes: a receiving unit to receive apparatus identification information that identifies transmitter and path identification information that identifies a data transfer path from another transmitter coupled to a local apparatus; a comparing unit to compare a value indicating an address assigned to the another transmitter to a value indicating an address assigned to the local apparatus; and a configuring unit to configure the local apparatus with apparatus identification information and path identification information determined by the local apparatus, or apparatus identification information and path identification information included in a frame received by the receiving unit, based on comparison results by the comparing unit.

### CROSS-REFERENCE TO RELATED APPLICATIONS

This application is based upon and claims the benefit of priority from the prior Japanese Patent Application No. 2010-120997 filed on May 26, 2010, the entire contents of which are incorporated herein by reference.

### FIELD

The embodiments discussed herein are related to a transmitter, a control information configuration method, and a control information configuration program.

### BACKGROUND

As a consequence of cost reductions in carrier networks and increased IP traffic demands, the switch from Synchronous Digital Hierarchy/Synchronous Optical NETwork (SDH/SONET) transmission schemes to packet transmission schemes is advancing. Packet transmission schemes have an advantage of better line usage efficiency compared to SDH/SONET transmission schemes, but since Layer 2 switches (L2SW) are used, path control cannot be performed by the carrier. Thus, packet transmission schemes have been unsuitable for carrier grade services.

Accordingly, in recent years the standardization of the Transport Profile of Multiprotocol Label Switching (MPLS-TP) in packet transmission schemes has been advancing. MPLS-TP enables a carrier to monitor the state of a network and control paths.

Also, standardization of Operation and Maintenance (OAM) to ascertain network operating conditions and detect faults or performance drops in packet transmission schemes has been advanced by the Internet Engineering Task Force (IETF). With OAM of packet transmission schemes, for each Maintenance Entity Group (MEG) given as a group subject to administration, an end point apparatus within a MEG is set as a Maintenance Entity End Point (MEP).

Also, with OAM of packet transmission schemes, an intermediate point apparatus within a MEG is set as a Maintenance Entity Intermediate Point (MIP), and OAM-specific packets are used for fault monitoring. A MEP transmits a Continuity Check Message (CCM), i.e. a frame for checking continuity, to a peer MEP at every cycle of a fixed period. Additionally, a MEP checks inter-MEP continuity by periodically receiving a CCM frame transmitted from a peer MEP at every cycle of a fixed period. In the case where a MEP does not receive a CCM frame for a given number of consecutive periods, the MEP treats the case as a Loss of Continuity (LOC), and transmits a warning. For related technology, see International Publication Pamphlet No. WO 2007/086157.

### SUMMARY

According to an aspect of the invention, a transmitter includes: a receiving unit to receive apparatus identification information that identifies transmitter and path identification information that identifies a data transfer path from another transmitter coupled to a local apparatus; a comparing unit to compare a value indicating an address assigned to the another transmitter to a value indicating an address assigned to the local apparatus; and a configuring unit to configure the local apparatus with apparatus identification information and path identification information determined by the local apparatus, or apparatus identification information and path identification information included in a frame received by the receiving unit, based on comparison results by the comparing unit.

The object and advantages of the invention will be realized and attained by at least the features, elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a transmitter in accordance with a first embodiment;

FIG. 2 illustrates an example configuration of a network that includes a transmitter in accordance with a second embodiment;

FIG. 3 illustrates a configuration of a transmitter in accordance with a second embodiment;

FIG. 4 illustrates an example MPLS-TP path OAM frame;

FIG. 5 illustrates an example OAM frame format;

FIG. 6 illustrates a CCM frame;

FIGS. 7A and 7B illustrate example automatic configuration initiation;

FIGS. 8A to 8C illustrate an example automatic configuration process;

FIG. 9 is a sequence diagram illustrating operations of a process on a network that includes a transmitter in accordance with a second embodiment;

FIG. 10 illustrates operations of an automatic configuration process conducted by a transmitter in accordance with a second embodiment;

FIGS. 11A and 11B illustrate automatic configuration during a fault;

FIGS. 12A and 12B illustrate automatic configuration during an apparatus replacement;

FIG. 13 illustrates operations of a process during a fault conducted by a transmitter in accordance with a third embodiment;

FIG. 14 illustrates operations of a process during an apparatus replacement conducted by a transmitter in accordance with a third embodiment; and

FIG. 15 illustrates a computer that executes a control information configuration program.

### DESCRIPTION OF EMBODIMENTS

In the related art, there has been a problem in that the burden of operational configuration imposed on the network administrator is large. More specifically, when transmitting a CCM frame to a peer MEP, a CCM frame is transmitted on the basis of a MEPID assigned to a peer MEP. Consequently, this involves the network administrator setting a MEPID for a recipient MEP in each MEP before the network is put into operation. As a result, the burden of operational configuration imposed on the network administrator is large.

Hereinafter, embodiments of a transmitter, a control information configuration method, and a control information configuration program disclosed in this specification will be described in detail and with reference to the attached drawings. Herein, a transmitter, control information configuration method, and control information configuration program disclosed in this specification are not limited by the following embodiments.

### First Embodiment

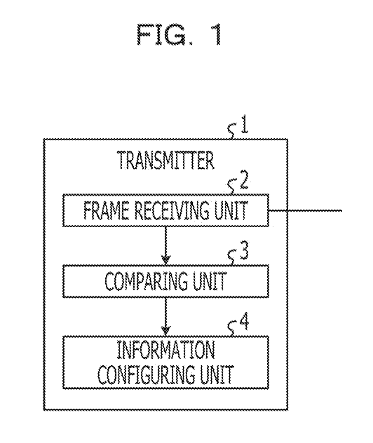

A configuration of a transmitter in accordance with a first embodiment will be described. FIG. 1 illustrates a configuration of a transmitter in accordance with a first embodiment. As illustrated in FIG. 1, a transmitter 1 includes a frame receiving unit 2, a comparing unit 3, and an information configuring unit 4. The transmitter 1 autonomously configures control information. The frame receiving unit 2 receives, from another transmitter coupled to the transmitter 1, a frame including apparatus identification information that identifies transmitter and path identification information that identifies a data transfer path. The frame receiving unit 2 may be realized by circuits (hardware) using an application-specific integrated circuit (ASIC) or a field-programmable gate array (FPGA), for example. Also, the frame receiving unit 2 may additionally include circuits (hardware) such as a CPU and memory, and may be configured to conduct the control with a program.

The comparing unit 3 compares a value indicating an address assigned to another transmitter to a value indicating an address assigned to the transmitter 1. The comparing unit 3 may be realized by circuits (hardware) using an application-specific integrated circuit (ASIC) or a field-programmable gate array (FPGA), for example. Also, the comparing unit 3 may additionally include circuits (hardware) such as a CPU and memory, and may be configured to conduct the control with a program. The information configuring unit 4, on the basis of comparison results according to the comparing unit 3, configures the transmitter 1 with apparatus identification information and path identification information determined by the transmitter 1, or with apparatus identification information and path identification information included in a frame received by the frame receiving unit 2. The information configuring unit 4 may be realized by circuits (hardware) using an application-specific integrated circuit (ASIC) or a field-programmable gate array (FPGA), for example. Also, the information configuring unit 4 may additionally include circuits (hardware) such as a CPU and memory, and may be configured to conduct the control with a program.

As described above, a transmitter 1 in accordance with a first embodiment configures itself with a MEGID and MEPIDs determined by the transmitter 1 or another apparatus on the basis of address value comparison results between the transmitter 1 and another apparatus. Consequently, a transmitter 1 in accordance with a first embodiment is able to autonomously configure control information and make it possible to reduce the burden of operational configuration imposed on the network administrator.

### Second Embodiment

In a second embodiment, first, a network that includes a transmitter in accordance with a second embodiment will be described. After that, a transmitter in accordance with a second embodiment will be described.

[Configuration of Network that Includes Transmitter in Accordance with Second Embodiment]

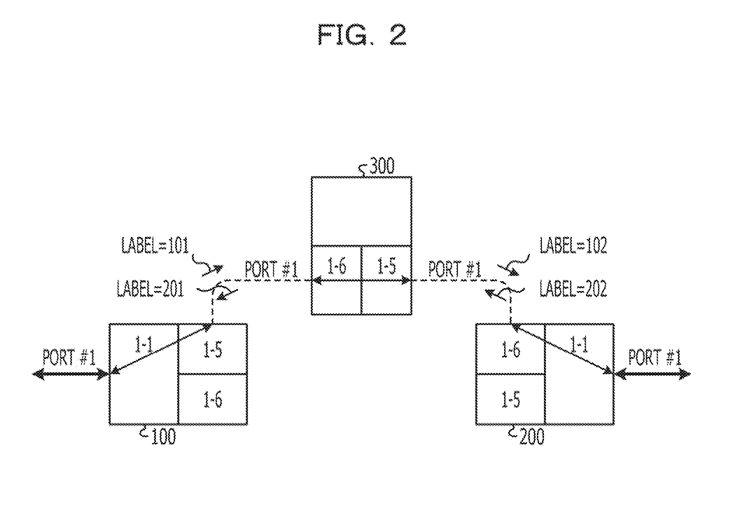

First, a configuration of a network that includes a transmitter in accordance with a second embodiment will be described. FIG. 2 illustrates an example configuration of a network that includes a transmitter in accordance with a second embodiment. As illustrated in FIG. 2, a network that includes a transmitter in accordance with a second embodiment includes a transmitter 100, a transmitter 200, and a relay apparatus 300. The transmitter 100 and the transmitter 200 are respectively coupled to the relay apparatus 300.

MPLS-TP is applied to a network that includes a transmitter in accordance with a second embodiment, and a path between the transmitter 100 and the transmitter 200 is configured. In other words, in a network that includes a transmitter in accordance with a second embodiment, there is a state of communication between the transmitter 100 and the transmitter 200, and data is sent and received by frames assigned with labels. Herein, a path is a communication path between arbitrary transmitter on a network that includes a plurality of transmitter. Additionally, relay apparatus may be interposed along a communication path in some cases.

As illustrated in FIG. 2, the transmitter 100 transmits a frame assigned with “Label: 101” to the transmitter 200 from the flow point 1-5-1-1. Also, the transmitter 100 receives a CCM frame assigned with “Label: 201” from the peer transmitter 200.

As illustrated in FIG. 2, the transmitter 200 transmits a frame assigned with “Label: 202” to the transmitter 100 from the flow point 1-6-1-1. Also, the transmitter 200 receives a frame assigned with “Label: 102” from the peer transmitter 100.

As illustrated in FIG. 2, the relay apparatus 300 replaces the label “101” assigned to the frame transmitted from the transmitter 100 with “102”, and transmits the frame to the transmitter 200. Also, the relay apparatus 300 replaces the label “202” assigned to the frame transmitted from the transmitter 200 to “201”, and transmits the frame to the transmitter 100. Herein, two transmitters and one relay apparatus are illustrated in FIG. 2, but in practice large numbers of transmitters and relay apparatus may be coupled to the transmitter 100, transmitter 200, or relay apparatus 300 in many cases.

[Configuration of Transmitter in Accordance with Second Embodiment]

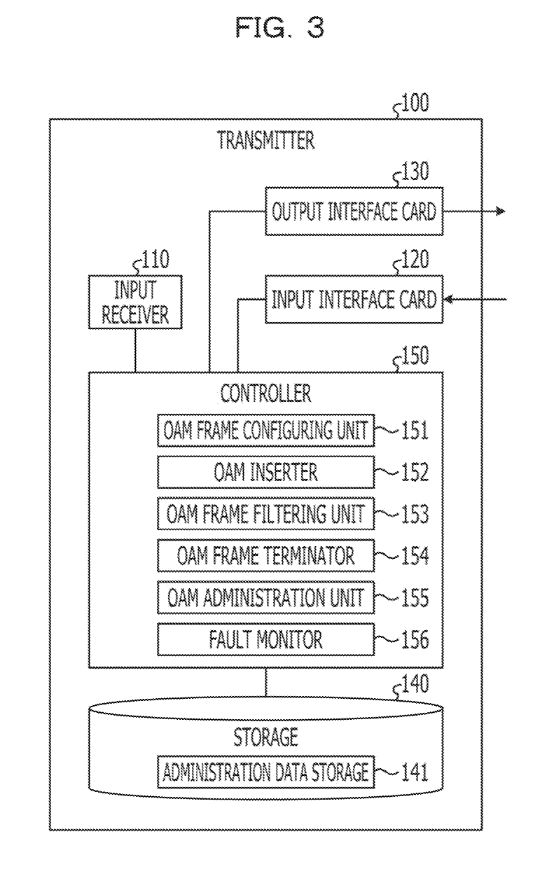

Next, a configuration of a transmitter in accordance with a second embodiment will be described. FIG. 3 illustrates a configuration of a transmitter 100 in accordance with a second embodiment. Herein, an example configuration of the transmitter 100 illustrated in FIG. 2 is described in FIG. 3, but a configuration of the transmitter 200 illustrated in FIG. 2 is also similar to the transmitter illustrated in FIG. 3.

As illustrated in FIG. 3, the transmitter 100 includes an input receiver 110, an input interface card 120, an output interface card 130, storage 140, and a controller 150. The transmitter 100 autonomously configures a MEGID and MEPIDs. Herein, one input interface card 120 and one output interface card 130, respectively, are described in FIG. 3, but in practice the transmitter 100 may have respective numbers of input interface cards 120 and output interface cards 130 equivalent to the number of ports. The input receiver 110, the input interface card 120, the output interface card 130, and the controller 150 may each be configured as follows. Each unit may be realized by circuits (hardware) using an application-specific integrated circuit (ASIC) or a field-programmable gate array (FPGA), for example. Also, each unit may additionally include circuits (hardware) such as a CPU and memory, and may be configured to conduct its control with a program.

The input receiver 110 receives various information input processes by the network administrator. For example, the input receiver 110 may receive input processes for path information or commands that enable automatic configuration of a MEGID and MEPIDs. The input interface card 120 is an interface card that controls input of frames transmitted by the transmitter 200 and relayed via the relay apparatus 300. The output interface card 130 is an interface card that controls transmission of frames input from the controller 150 later described to the transmitter 200. Herein, the input interface card 120 and the output interface card 130 are interface cards corresponding to the slot 1-5 in the transmitter 100 illustrated in FIG. 2.

As illustrated in FIG. 3, the storage 140 includes administration data storage 141, and stores various data used by the transmitter 100 and processing results by the controller 150 later described. The storage 140 is a storage apparatus such as random access memory (RAM), read-only memory (ROM), flash memory or other semiconductor memory element, a hard disk, or an optical disc, for example. The administration data storage 141 stores control information such as a MEGID and MEPIDs configured by the controller 150 later described.

The controller 150 includes an OAM frame configuring unit 151, an OAM inserter 152, an OAM frame filtering unit 153, an OAM frame terminator 154, an OAM administration unit 155, and a fault monitor 156. The controller 150 may be an integrated circuit such as an application-specific integrated circuit (ASIC) or a field-programmable gate array (FPGA), or an electronic circuit such as a central processing unit (CPU) or a microprocessor unit (MPU), for example.

The OAM frame configuring unit 151 constructs an OAM frame on the basis of control by the OAM administration unit 155 later described. More specifically, the OAM frame configuring unit 151, on the basis of control by the OAM administration unit 155, constructs an OAM frame configured with a path MEGID, the MEPID of the local node, the MEPID of a peer node, and an Auto Flag indicating whether or not automatic configuration is enabled.

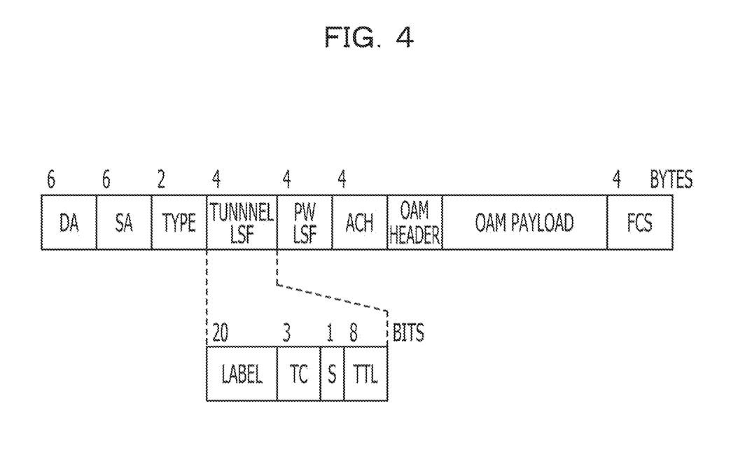

An OAM frame transmitted from a transmitter 100 to a transmitter 200 will now be described using FIGS. 4 to 6. FIG. 4 illustrates an example MPLS-TP path OAM frame. As illustrated in FIG. 4, an MPLS-TP path OAM frame includes a 6-byte “Destination Address (DA)” in which is set the Media Access Control (MAC) address of a destination node interface card. An MPLS-TP path OAM frame also includes a 6-byte “Source Address (SA)” in which is set the MAC address of a source node interface card, and a 2-byte “Type” in which is set a frame type.

Also, an MPLS-TP path OAM frame includes a 4-byte “Tunnel LSF” and a 4-byte “PW LSF” in which are set a channel label and a path label. An MPLS-TP path OAM frame also includes a 4-byte “ACH” in which a frame version is set, and a 4-byte Frame Check Sequence (FCS) used in order to detect error. The “Tunnel LSF” includes a label, a “Time Code (TC)” indicating a time interval, an “5” field for identifying a shim header, and a “Time To Live (TTL)” indicating a label's lifetime.

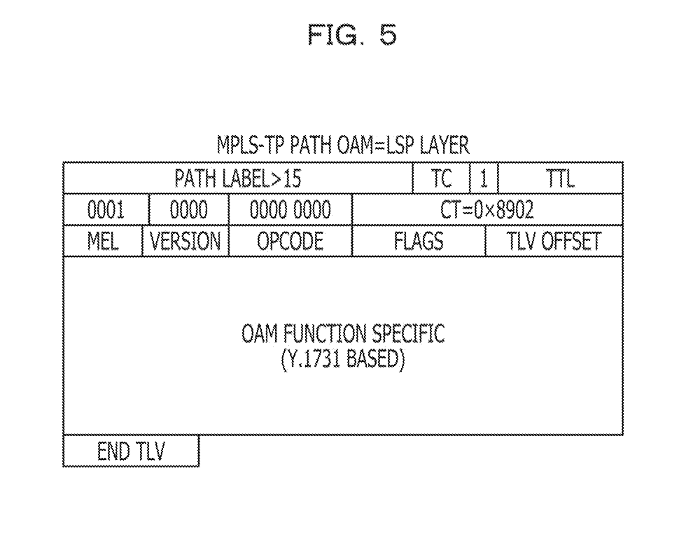

Additionally, an MPLS-TP path OAM frame includes an “OAM payload”, which is a region in which is set data used by OAM, and an “OAM header”, which is an OAM header region. FIG. 5 illustrates an example OAM frame format. The OAM frame illustrated in FIG. 5 corresponds to the part from “PW LSF” to “OAM payload” illustrated in FIG. 4.

As illustrated in FIG. 5, an OAM frame includes a “path label>15”, a “TC”, an S field “1”, and a “TTL” in the “PW LSF”. An OAM frame also includes a function type “0001”, a version “0000”, a reserve “0000 0000”, and a channel type “0x8902” in the “ACH”.

Additionally, an OAM frame includes fixed regions such as “MEL” in which is set a MEG label, “Version” in which is set frame version information, “OpCode” in which is set frame code information, and “Flags” in which are set flags. OpCode is a value associated with information regarding a node related to the OAM type. Consequently, OpCode is set with a value that differs according to which OAM functions a frame is used for.

Besides fixed regions such as “MEL”, “Version”, “OpCode”, and “Flags”, an OAM frame includes a “Type Length Value (TLV) Offset”, which is a variable region in which are set various parameters. Type indicates the type of an item included in Value. Length indicates the length of Value. Value is the packet data portion. Additionally, respectively different values are set in the “TLV Offset” depending on which parameters are set in the frame.

Additionally, an OAM frame includes an “OAM function specific (Y.1731 based)” in which are set parameters for functions specific to OAM standardized as “Y.1731”, and an “End TLV”, which is the last TLV.

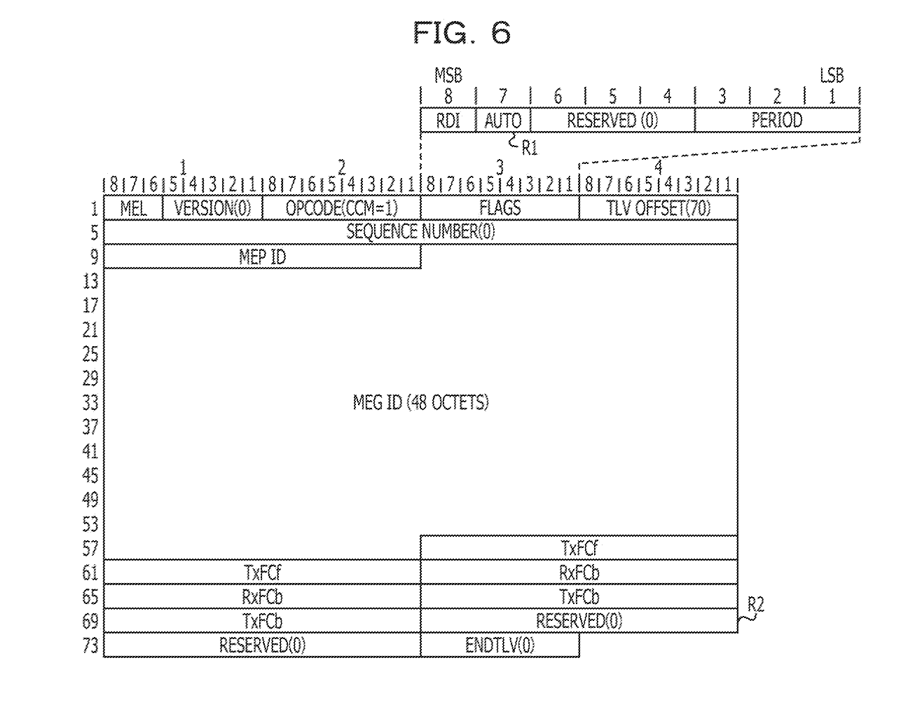

FIG. 6 illustrates a CCM frame. A CCM frame is an OAM frame illustrated in FIG. 5 that has been configured for CCM. As illustrated in FIG. 6, a CCM frame is configured with “MEL”, “Version”, “Flags”, “OpCode (CCM=1)”, and “TLV offset”.

Additionally, a CCM frame is configured with a “Sequence number (0)” indicating a number when the frame is transmitted, a “MEPID”, and a “MEGID (48 octets)” in a region corresponding to “OAM function specific” in FIG. 5. Also, a CCM frame includes, in a region corresponding to “OAM function specific” in FIG. 5, a “TxFCf”, “RxFCb”, and a “TxFCb” indicating frame counter values when the frame is sent or received. Also, a CCM frame includes a “Reserved (0)” in a region corresponding to “OAM function specific” in FIG. 5.

The OAM frame configuring unit 151, on the basis of control by the OAM administration unit 155 later described, constructs an OAM frame configured with a MEGID, MEPID, and Flags illustrated in FIG. 6. Additionally, the OAM frame configuring unit 151 sets the MAC address of the port that will send the frame in the “SA” illustrated in FIG. 4.

More specifically, the OAM frame configuring unit 151 sets an Auto Flag indicating whether or not automatic configuration is enabled in an “AUTO” region R1 provided in “Reserved (0)” of “Flags”, as illustrated in FIG. 6. For example, the OAM frame configuring unit 151 may set “1” in the region R1, which indicates that automatic configuration is enabled. Alternatively, the OAM frame configuring unit 151 may set “0” in the region R1, which indicates that automatic configuration is disabled.

Also, the OAM frame configuring unit 151 sets “2” as the MEPID of a desired peer node in “MEPID” illustrated in FIG. 6. The OAM frame configuring unit 151 also sets “0004” as the desired MEGID in “MEGID” illustrated in FIG. 6. The OAM frame configuring unit 151 also sets “1” as the desired MEPID for the local node in the “Reserved (0)” region R2 illustrated in FIG. 6.

Returning to FIG. 3, the OAM inserter 152 inserts an OAM frame constructed by the OAM frame configuring unit 151 and transmitted from the output interface card 130. The OAM frame filtering unit 153 receives, from another transmitter coupled to the transmitter 100, a frame including apparatus identification information that identifies transmitter and path identification information that identifies a data transfer path.

More specifically, the OAM frame filtering unit 153 retrieves an OAM frame including a MEGID, MEPID, etc. from a signal transmitted by a peer node on a set path. For example, the OAM frame filtering unit 153 may retrieve an OAM frame configured with “MEGID: 000B, transmitter 200 MEPID: 1, transmitter 100 MEPID: 2, Auto Flag: 1”, etc. from a signal transmitted by a transmitter 200.

The OAM frame terminator 154 terminates an OAM frame retrieved by the OAM frame filtering unit 153, and informs the OAM administration unit 155 later described of information included in the OAM frame. For example, the OAM frame terminator 154 may inform the OAM administration unit 155 of “MEGID: 000B, transmitter 200 MEPID: 1, transmitter 100 MEPID: 2, Auto Flag: 1”, etc. in an OAM frame retrieved by the OAM frame filtering unit 153.

The OAM administration unit 155 causes the OAM frame configuring unit 151 to construct an OAM frame in the case where a command enabling automatic configuration of OAM is input by the network administrator. More specifically, if a command enabling automatic configuration is input, the OAM administration unit 155 may cause the OAM frame configuring unit 151 to construct an OAM frame configured with default values such as the MEGID of a set path, the MEPID of the local node, and the MEPID of a peer node.

For example, the OAM administration unit 155 may cause the OAM frame configuring unit 151 to construct an OAM frame configured with “MEGID: 000A, local node MEPID: 1, peer node MEPID: 2, Auto Flag: 1”, etc.

The OAM administration unit 155 also compares a value indicating an address assigned to another transmitter to a value indicating an address assigned to the local apparatus. Then, the OAM administration unit 155, on the basis of the comparison results, configures the local apparatus with apparatus identification information and path identification information determined by the local apparatus, or with apparatus identification information and path identification information included in a frame acquired by the OAM frame filtering unit 153.

More specifically, the OAM administration unit 155 compares values indicating MAC addresses as the addresses respectively assigned to the local apparatus and another transmitter. In the case where a value indicating the MAC address of the local apparatus is greater than a value indicating the MAC address of the other transmitter in the comparison results, the OAM administration unit 155 configures the local apparatus with apparatus identification information and path identification information determined by the local apparatus. In contrast, in the case where a value indicating the MAC address of the local apparatus is less than a value indicating the MAC address of the other transmitter, the OAM administration unit 155 configures the local apparatus with apparatus identification information and path identification information included in a frame acquired by the OAM frame filtering unit 153.

Furthermore, the OAM administration unit 155 causes the OAM frame configuring unit 151 to construct a configuration request for the other transmitter in the case of configuring the local apparatus with apparatus identification information and path identification information determined by the local apparatus. In contrast, the OAM administration unit 155 causes the OAM frame configuring unit 151 to construct a response for the other transmitter indicating that configuration is complete in the case of configuring the local apparatus with apparatus identification information and path identification information included in a frame acquired by the OAM frame filtering unit 153.

For example, the OAM administration unit 155 may execute processing as follows if an OAM frame configured with “MEGID: 000B, transmitter 200 MEPID: 1, transmitter 100 MEPID: 2, Auto Flag: 1”, etc. is received from a transmitter 200. First, the OAM administration unit 155 compares the binary value of the MAC address of the transmitter 200 set in the “SA” of the received frame to the binary value of the MAC address set for a port of the local apparatus.

In the case where the binary value of the MAC address of the local apparatus is greater than the binary value of the MAC address of the transmitter 200, the OAM administration unit 155 determines itself to be a host that will determine the MEGID and MEPIDs of the path OAM, and sets a MEGID and MEPIDs. For example, the OAM administration unit 155 may determine itself to be a host by comparison of binary values of MAC addresses, set “MEGID: 0004, transmitter 100 MEPID: 1, transmitter 200 MEPID: 2”, and store the configuration in the administration data storage 141.

The OAM administration unit 155 transmits a configuration request to the peer node, e.g. the transmitter 200. More specifically, the OAM administration unit 155 causes the OAM frame configuring unit 151 to construct an OAM frame including the set MEGID and MEPIDs.

In contrast, in the case where the binary value of the MAC address of the local apparatus is less than the binary value of the MAC address of the transmitter 200, the OAM administration unit 155 determines itself to be a client that will configure the local apparatus with a MEGID and MEPIDs of a path OAM set by a peer node. For example, the OAM administration unit 155 may configure the local apparatus with “MEGID: 000B, transmitter 200 MEPID: 1, transmitter 100 MEPID: 2” received from the transmitter 200, and store the configuration in the administration data storage 141.

The OAM administration unit 155 transmits information indicating that configuration is complete to the transmitter 200. For example, the OAM administration unit 155 may cause the OAM frame configuring unit 151 to construct an OAM frame configured with “MEGID: 000B, transmitter 200 MEPID: 1, transmitter 100 MEPID: 2”.

The OAM administration unit 155 causes the OAM frame configuring unit 151 to construct a CCM frame on the basis of administration data such as a MEGID and MEPIDs stored by the administration data storage 141, and causes a CCM frame to be periodically transmitted to the transmitter 200.

The fault monitor 156 monitors whether or not a fault has occurred for each path OAM. For example, the fault monitor 156 may determine that a fault has occurred in the case where CCM frames sent and received on a path OAM are not received for a fixed period.

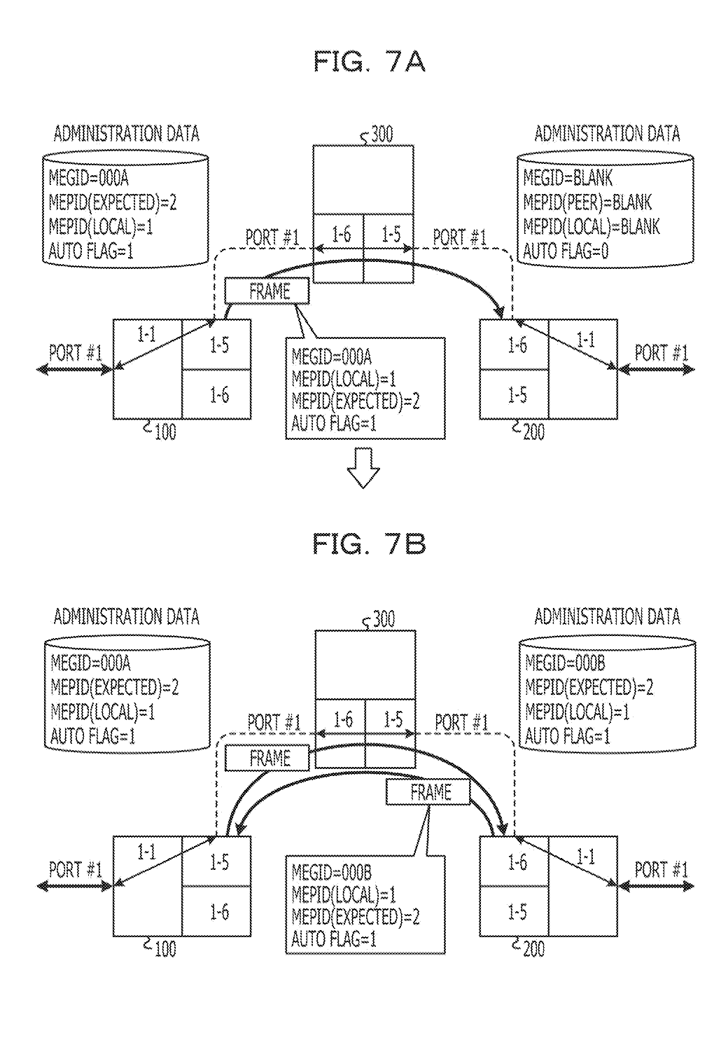

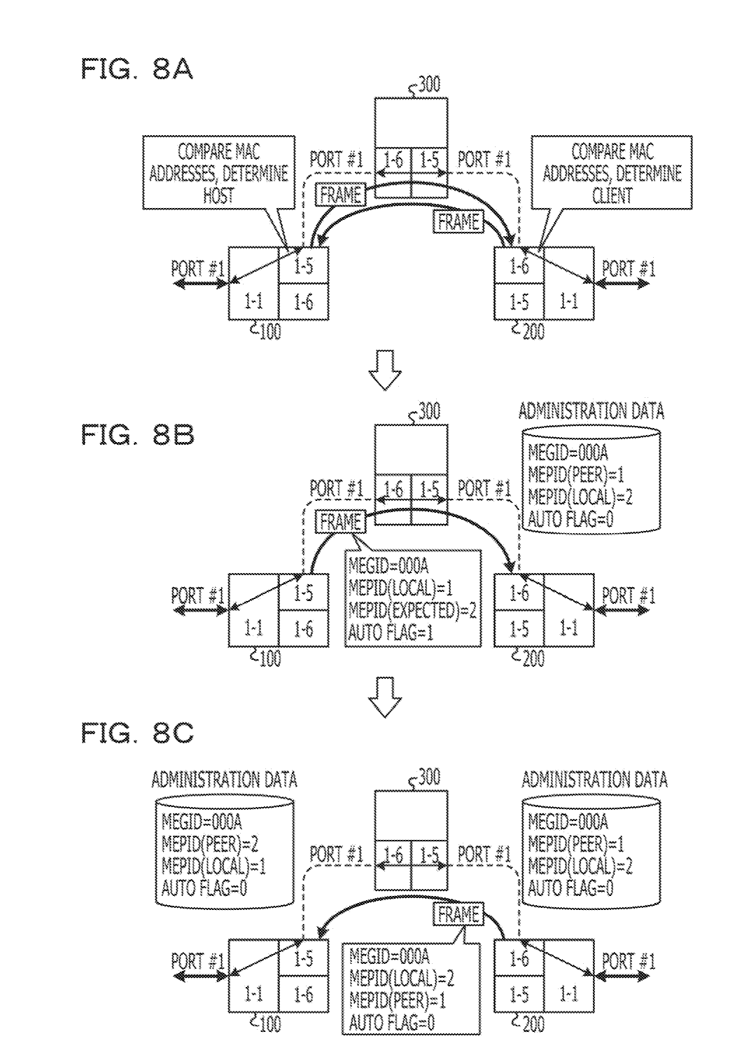

Example automatic construction of control information by a transmitter in accordance with a second embodiment will now be described using FIGS. 7A and 7B and FIGS. 8A to 8C. In FIGS. 7A and 7B and FIGS. 8A to 8C, a network is illustrated wherein a transmitter 100 and a transmitter 200 are respectively coupled to a relay apparatus 300. Additionally, MPLS-TP is applied to the network illustrated in these drawings, and a path is configured between the transmitter 100 and the transmitter 200. Also, as illustrated in these drawings, respective administration data for the transmitter 100 and the transmitter 200 is illustrated.

FIGS. 7A and 7B illustrate example automatic configuration initiation. FIG. 7A illustrates processing after automatic configuration of a MEGID and MEPIDs of a path OAM is enabled for a transmitter 100 by the network administrator. As illustrated in FIG. 7A, if automatic configuration is enabled, the OAM administration unit 155 of the transmitter 100 causes the OAM frame configuring unit 151 to construct an OAM frame configured with default values for “MEGID, MEPID (expected value), MEPID (local node)”.

For example, the OAM frame configuring unit 151, on the basis of control by the OAM administration unit 155, may construct an OAM frame configured with “MEGID=000A, MEPID (expected value)=2, MEPID (local node)=1, Auto Flag=1”. The OAM inserter 152 inserts the OAM frame configured by the OAM frame configuring unit 151, and transmits the frame from the output interface card 130 to the transmitter 200.

Herein, the MEPID (expected value) refers to a MEPID expected to be set as the MEPID by the transmitter 200. In other words, the transmitter 100 transmits to the transmitter 200 an OAM frame configured with arbitrary values for the path MEGID, the local node MEPID, and the peer node MEPID. The transmitter 100 keeps transmitting an OAM frame configured with “MEGID=000A, MEPID (expected value)=2, MEPID (local node)=1, Auto Flag=1” until an OAM frame is received from the transmitter 200.

Meanwhile, since a command enabling automatic configuration has not been executed for the transmitter 200, the “MEGID, MEPID (peer node), MEPID (local node)” of the transmitter 200 are “blank”, as illustrated by the administration data of the transmitter 200 in FIG. 7A. Also, the “Auto Flag” is “0”.

As illustrated in FIG. 7B, if automatic configuration of a MEGID and MEPIDs of a path OAM is enabled for the transmitter 200, the OAM administration unit 155 of the transmitter 200 causes an OAM frame configured with respective information to be constructed. For example, the OAM administration unit 155 of the transmitter 200 may cause the OAM frame configuring unit 151 to construct an OAM frame configured with “MEGID=000B, MEPID (expected value)=2, MEPID (local node)=1, Auto Flag=1”. The transmitter 200 transmits the constructed OAM frame to the transmitter 100 as illustrated in FIG. 7B.

In other words, the transmitter 100 and the transmitter 200 each transmits to its peer transmitter an OAM frame arbitrarily configured by itself. FIGS. 8A to 8C illustrate an example automatic configuration process. FIGS. 8A to 8C illustrate an automatic configuration process after the automatic configuration initiation in FIGS. 7A and 7B. For example, as illustrated in FIG. 8A, if an OAM frame is received from the transmitter 200, the transmitter 100 compares the binary value of the MAC address set in the “SA” of the OAM frame to the binary value of the MAC address of the local node. The transmitter 100 determines itself to be the host, since the binary value of the MAC address of the local node is greater than the binary value of the MAC address of the transmitter 200.

Also, as illustrated in FIG. 8A, if an OAM frame is received from the transmitter 100, the transmitter 200 compares the binary value of the MAC address set in the “SA” of the OAM frame to the binary value of the MAC address of the local node. The transmitter 200 determines itself to be the client, since the binary value of the MAC address of the local node is less than the binary value of the MAC address of the transmitter 100.

Also, as illustrated in FIG. 8B, the host transmitter 100 transmits to the transmitter 200 an OAM frame configured with “MEGID=000A, MEPID (expected value)=2, MEPID (local node)=1, Auto Flag=1” as a configuration request. Since its local node is the client, the transmitter 200 configures the local node with the MEGID and MEPIDs set by the transmitter 100. In other words, as illustrated in FIG. 8B, the transmitter 200 stores “MEGID=000A, MEPID (peer node)=1, MEPID (local node)=2, Auto Flag=0” as administration data.

Also, as illustrated in FIG. 8C, the transmitter 200 transmits to the transmitter 100 an OAM frame configured with “MEGID=000A, MEPID (local node)=2, MEPID (peer node)=1, Auto Flag=0” as a notification indicating that configuration of the local node is complete. The transmitter 100, upon receiving the OAM frame from the transmitter 200, determines that automatic configuration is complete, and sets “Auto Flag” to “0”.

As described above, the transmitter 100 and the transmitter 200 uses OAM frames to autonomously configure a MEGID and MEPIDs of a path OAM. Additionally, the transmitter 100 and the transmitter 200 uses the automatically configured MEGID and MEPIDs to periodically send and receive CCM frames and execute fault monitoring.

Next, operations of a process on a network that includes a transmitter in accordance with a second embodiment, and operations of a process conducted by a transmitter in accordance with a second embodiment will be described. Hereinafter, operations of a process on a network that includes a transmitter in accordance with a second embodiment will be described first, and then operations of a process conducted by a transmitter in accordance with a second embodiment will be described.

[Operations of Process on Network that Includes Transmitter in Accordance with Second Embodiment]

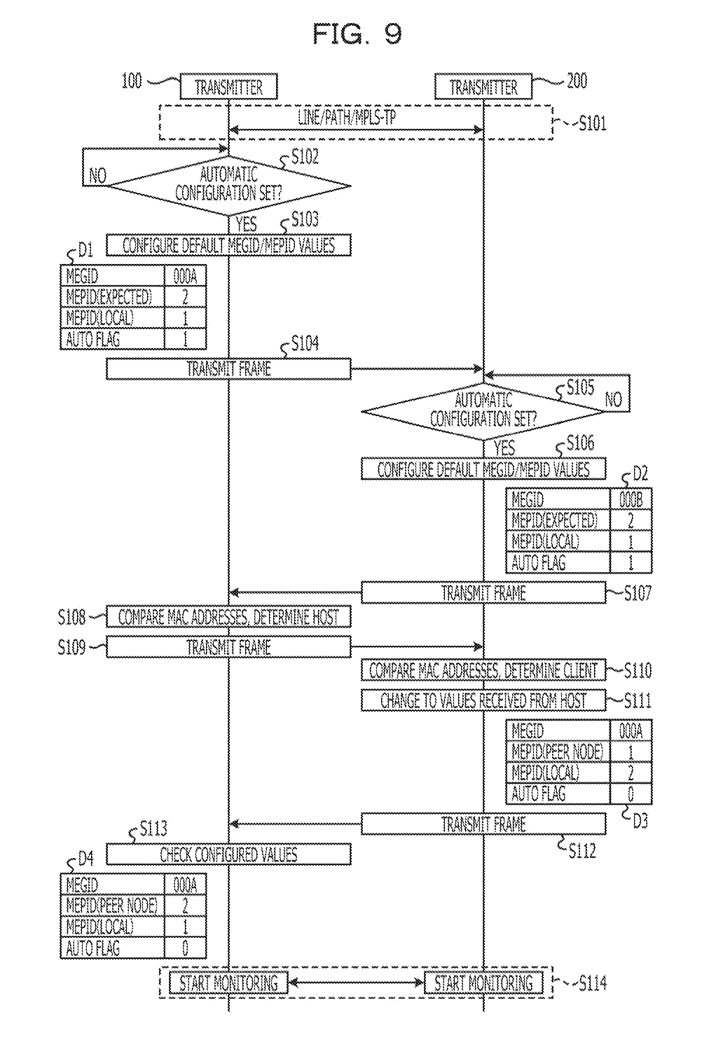

FIG. 9 is a sequence diagram illustrating operations of a process on a network that includes a transmitter in accordance with a second embodiment. As illustrated in FIG. 9, first, on a network that includes a transmitter in accordance with a second embodiment, an administrator configures a line, path, and MPLS-TP between a transmitter 100 and a transmitter 200 (S101). The transmitter 100 determines whether or not automatic configuration has been set (S102).

At this point, if automatic configuration is enabled by the administrator (S102, Yes), the transmitter 100 sets default values for the MEGID and MEPIDs (S103). For example, the transmitter 100 may set “MEGID=000A, MEPID (expected value)=2, MEPID (local node)=1, Auto Flag=1” as illustrated by data D1 in FIG. 9. The transmitter 100 transmits the configured OAM frame to the transmitter 200 (S104).

If various configuration is executed by the administrator in S101, the transmitter 200 determines whether or not automatic configuration has been set (S105). At this point, if automatic configuration is enabled by the administrator (S105, Yes), the transmitter 200 sets default values for the MEGID and MEPIDs (S106).

For example, the transmitter 200 may set “MEGID=000B, MEPID (expected value)=2, MEPID (local node)=1, Auto Flag=1” as illustrated by data D2 in FIG. 9. The transmitter 200 transmits the configured OAM frame to the transmitter 100 (S107).

Additionally, if an OAM frame is received from the transmitter 200, the transmitter 100 compares MAC addresses, determines from the comparison results that the local node is the host (S108), and transmits a configuration request frame (S109). If a configuration request frame is received, the transmitter 200 compares MAC addresses, determines from the comparison results that the local node is the client (S110), and changes the MEGID and MEPIDs to the values received from the host (S111).

For example, the transmitter 200 may set “MEGID=000A, MEPID (peer node)=1, MEPID (local node)=2, Auto Flag=0” as illustrated by data D3 in FIG. 9. The transmitter 200 transmits a frame indicating that configuration is complete to the transmitter 100 (S112). For example, the transmitter 200 may transmit a frame configured with “MEGID=000A, MEPID (peer node)=1, MEPID (local node)=2, Auto Flag=0” to the transmitter 100.

If a configuration complete frame is received from the transmitter 200, the transmitter 100 checks the configuration values (S113). In the case where the values are identical to the values configured in the local node, the transmitter 100 determines that automatic configuration is complete, and sets “Auto Flag” to “0” as illustrated by data D4 in FIG. 9. After that, the transmitter 100 and transmitter 200 initiate monitoring with CCM frames using the set MEGID and MEPIDs (S114).

Herein, in the process operations described above, a case is described wherein automatic configuration for the transmitter 100 is executed before the transmitter 200. However, in practice, S102 to S104 in the transmitter 100 and S105 to S107 in the transmitter 200 are executed in parallel. Furthermore, the transmission of an OAM frame in S104 and S107 is periodically executed until an OAM frame is received from a peer node.

Also, in the process operations described above, a case is described wherein the transmitter 100 becomes the host. However, when the MAC address of the transmitter 100 is less than the MAC address of the transmitter 200, the transmitter 100 is determined as the client. Also, the transmitter 100 and the transmitter 200 are in a standby state until automatic configuration is enabled (S102, No and S105, No).

[Operations of Automatic Configuration Process Conducted by Transmitter in Accordance with Second Embodiment]

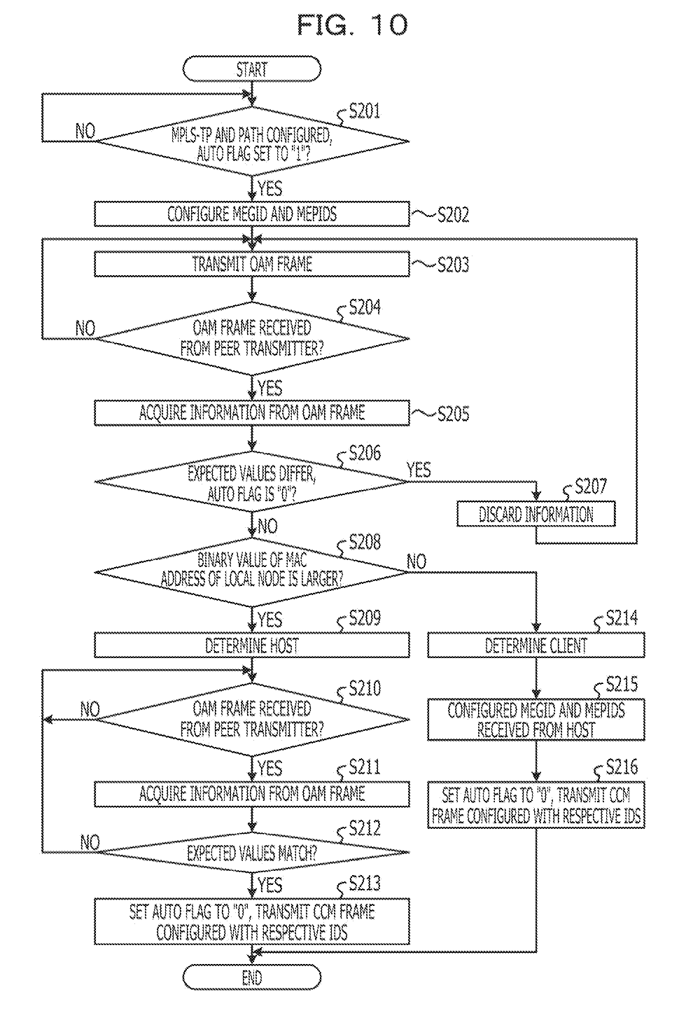

FIG. 10 illustrates operations of an automatic configuration process conducted by a transmitter in accordance with a second embodiment. As illustrated in FIG. 10, if MPLS-TP and a path are configured and the Auto Flag is set to “1” in a transmitter in accordance with a second embodiment (S201, Yes), the OAM administration unit 155 configures a MEGID and MEPIDs (S202). More specifically, the OAM administration unit 155 causes the OAM frame configuring unit 151 to construct an OAM frame configured with a path MEGID, a local node MEPID, and a MEPID expected to be configured by a peer node.

The OAM inserter 152 inserts an OAM frame constructed by the OAM frame configuring unit 151, and transmits the frame to a peer node (S203). At this point, the input interface card 120 determines whether or not an OAM frame has been received from a peer transmitter (S204).

At this point, in the case where an OAM frame is received from a peer transmitter (S204, Yes), the OAM administration unit 155 acquires information from the OAM frame (S205). More specifically, the OAM administration unit 155 receives MEPID, MEGID, and Auto Flag information acquired by the OAM frame filtering unit 153. Herein, a transmitter in accordance with a second embodiment keeps transmitting an OAM frame until an OAM frame is received from a peer transmitter (S204, No).

The OAM administration unit 155 determines whether or not the expected values differ and the Auto Flag is “0” (S206). In other words, in S206 of FIG. 10, the OAM administration unit 155 determines whether or not automatic configuration is enabled in the peer node. At this point, in the case where the expected values differ and the Auto Flag is “0” (S206, Yes), the OAM administration unit 155 discards the information (S207) and returns to S203 in FIG. 10.

In contrast, in the case where the expected values are identical or the Auto Flag is not “0” (S206, No), the OAM administration unit 155 determines whether or not the binary value of the MAC address of the local node is larger (S208). More specifically, the OAM administration unit 155 compares the binary value of the MAC address of the peer node set in an OAM frame to the binary value of the MAC address of the local node, and determines whether or not the binary value of the MAC address of the local node is larger.

At this point, in the case where the binary value of the MAC address of the local node is larger (S208, Yes), the OAM administration unit 155 determines the local node to be the host (S209), and determines whether or not an OAM frame has been received from a peer transmitter (S210). More specifically, the OAM administration unit 155, in the case where it is determined to be the host, determines whether or not an OAM frame indicating that configuration is complete has been received from a peer node.

In the case where an OAM frame is received (S210, Yes), the OAM administration unit 155 acquires information from the OAM frame (S211), and determines whether or not the information matches the expected value (S212). More specifically, the OAM administration unit 155 determines whether or not the acquired information is identical to the MEGID and MEPIDs configured in the local node.

In the case were the information matches the expected value (S212, Yes), the OAM administration unit 155 determines that configuration of the peer node is complete, sets the Auto Flag to “0”, and transmits a CCM frame configured with respective IDs to the peer node (S213). In contrast, in the case where the information does not match the expected value (S212, No) and in the case where an OAM frame is not received from a peer transmitter (S210, No), the OAM administration unit 155 stands by to receive an OAM frame.

In the case where the binary value of the MAC address of the local node is smaller in the determination by comparison of MAC addresses in S208 of FIG. 10 (S208, No), the OAM administration unit 155 determines that the local node is the client (S214). The OAM administration unit 155 configures the local node with a MEGID and MEPIDs received from the host (S215). The OAM administration unit 155 sets the Auto Flag to “0”, and transmits a CCM frame configured with respective IDs to the peer node (S216).

### Advantages of Second Embodiment

As described above, according to a second embodiment, an OAM frame filtering unit 153 receives a frame, which includes MEPIDs identifying transmitter and a MEGID identifying a path, from another transmitter coupled to the local apparatus. An OAM administration unit 155 compares a value indicating an address assigned to the other transmitter to a value indicating an address assigned to the local apparatus. Furthermore, the OAM administration unit 155, on the basis of the comparison results, configures the local apparatus with a MEGID and MEPIDs determined by the local apparatus or with a MEGID and MEPIDs included in a frame received by the OAM frame filtering unit 153. Consequently, a transmitter in accordance with a second embodiment is able to autonomously configure a MEGID and MEPIDs used to send and receive CCM frames, thereby making it possible to reduce the burden of operational configuration imposed on the network administrator.

According to a second embodiment, a transmitter in accordance with a second embodiment autonomously configures a MEGID and MEPIDs used to send and receive CCM frames, thereby making it possible to reduce administrator operations and reduce the apparatus construction time.

According to a second embodiment, the OAM administration unit 155 compares values indicating MAC addresses as the addresses respectively assigned to the local apparatus and another transmitter. In the case where a value indicating the MAC address of the local apparatus is greater than a value indicating the MAC address of the other transmitter in the comparison results, the OAM administration unit 155 configures the local apparatus with MEPIDs and a MEGID determined by the local apparatus. In the case where a value indicating the MAC address of the local apparatus is less than a value indicating the MAC address of the other transmitter, the OAM administration unit 155 configures the local apparatus with MEPIDs and a MEGID included in a frame received by the OAM frame filtering unit 153. Consequently, a transmitter in accordance with a second embodiment makes it possible to easily make comparisons among respective apparatus by using values that differ among respective apparatus.

According to a second embodiment, in the case where MEPIDs and a MEGID determined by the local apparatus are configured in the local apparatus by the OAM administration unit 155, an OAM inserter 152 transmits a configuration request to the other transmitter. The OAM frame filtering unit 153 receives, from the other transmitter, a response to the configuration request transmitted by the OAM inserter 152. Consequently, a transmitter in accordance with a second embodiment makes it possible to rapidly configure apparatus.

According to a second embodiment, the OAM frame filtering unit 153 receives a configuration request. The OAM administration unit 155, obeying the configuration request received by the OAM frame filtering unit 153, configures the local apparatus with MEPIDs and a MEGID included in a received frame. In the case where MEPIDs and a MEGID are configured by the OAM administration unit 155, the OAM inserter 152 transmits a response indicating that configuration is complete to the other transmitter. Consequently, a transmitter in accordance with a second embodiment makes it possible to avoid configuration errors.

### Third Embodiment

In the above second embodiment, automatic configuration of a MEGID and MEPIDs when constructing a network was described. In a third embodiment, a case is described wherein a MEGID and MEPIDs are automatically reconfigured when a fault occurs in a running network.

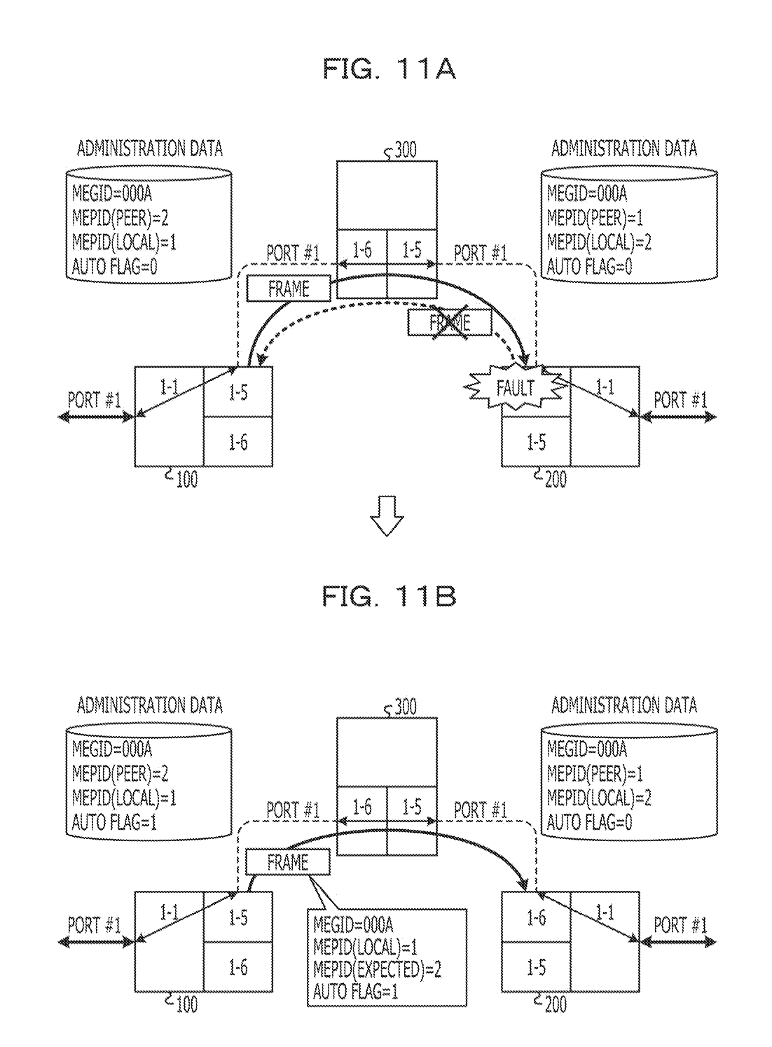

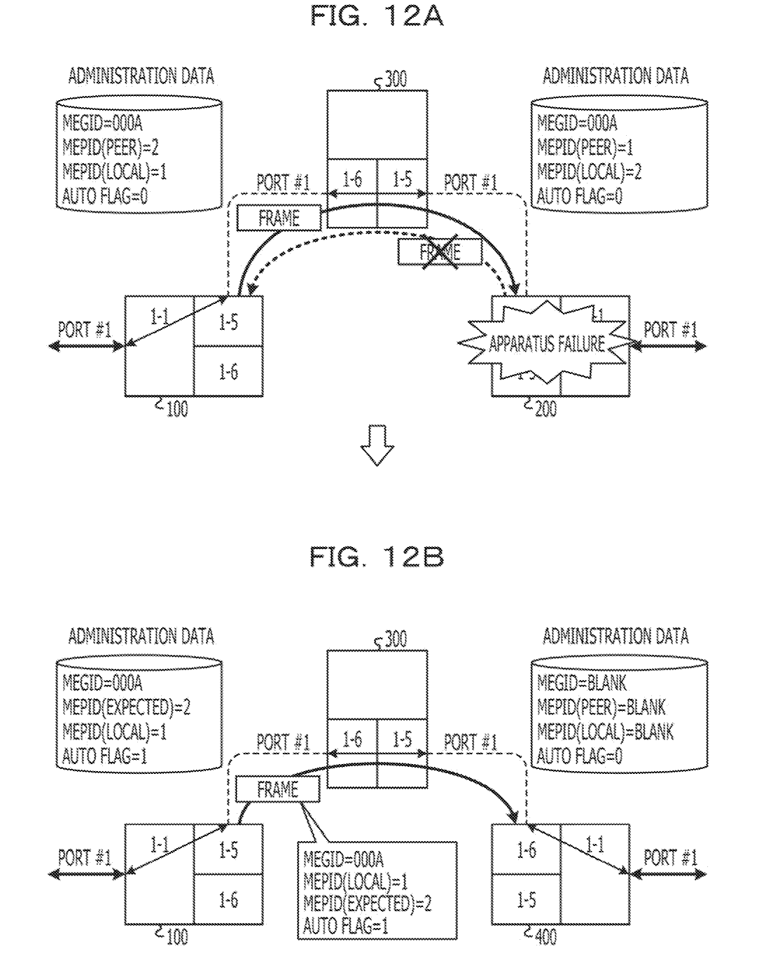

Automatic configuration by a transmitter in accordance with a third embodiment will be described using FIGS. 11A to 11B and FIGS. 12A to 12B. FIGS. 11A and 11B illustrate automatic configuration during a fault. In FIGS. 11A and 11B, a network is illustrated wherein a transmitter 100 and a transmitter 200 are respectively coupled to a relay apparatus 300. Additionally, MPLS-TP and a path are configured in the network illustrated in FIGS. 11A and 11B, and the sending and receiving of CCM frames between the transmitter 100 and the transmitter 200 is executed using an automatically configured MEGID and MEPIDs. Also, as illustrated in FIGS. 11A and 11B, respective administration data for the transmitter 100 and the transmitter 200 is illustrated.

As illustrated in FIG. 11A, if a fault occurs at a port of the transmitter 200 and reaches a condition wherein CCM frames from the transmitter 200 do not arrive, the fault monitor 156 of the transmitter 100 detects a path fault. The OAM administration unit 155, upon detection of a fault by the fault monitor 156, sets the Auto Flag to “1”, and stands by until the fault is repaired.

At this point, if the fault is repaired, the OAM administration unit 155 causes the OAM frame configuring unit 151 to construct an OAM frame based on administration data stored by the administration data storage 141. For example, as illustrated in FIG. 11B, the OAM administration unit 155 may cause the OAM frame configuring unit 151 to construct an OAM frame configured with “MEGID=000A, MEPID (expected value)=2, MEPID (local node)=1, Auto Flag=1”.

The OAM inserter 152 inserts the OAM frame, and transmits the OAM frame to the transmitter 200. If an OAM frame is received from the transmitter 100, the OAM administration unit 155 of the transmitter 200 compares binary values of MAC addresses, and determines that the local node is the client. The transmitter 200 resumes the sending and receiving of CCM frames using administration data stored in the administration data storage 141 of the local node.

FIGS. 12A and 12B illustrate automatic configuration during an apparatus replacement. In FIGS. 12A and 12B, conditions are illustrated wherein, on a network wherein a transmitter 100 and a transmitter 200 are respectively coupled to a relay apparatus 300, the transmitter 200 is replaced with a transmitter 400 due to a failure. As illustrated in FIG. 12A, if an apparatus failure occurs in the running transmitter 200 and reaches a condition wherein CCM frames from the transmitter 200 do not arrive, the fault monitor 156 of the transmitter 100 detects a path fault.

The OAM administration unit 155, upon detection of a fault by the fault monitor 156, sets the Auto Flag to “1” and stands by until the fault is repaired. At this point, as illustrated in FIG. 12B, in the case where the transmitter 200 is replaced with the transmitter 400 by an administrator, administration data in the transmitter 400 is in an initial state. In other words, as illustrated in FIG. 12B, the administration data in the transmitter 400 is “MEGID=blank, MEPID (peer node)=blank, MEPID (local node)=blank, Auto Flag=0”.

Consequently, the administrator configures MPLS-TP and a path between the transmitter 100 and the transmitter 400, and enables automatic configuration of path OAM. If MPLS-TP and a path is configured between the transmitter 100 and the transmitter 400 by the administrator, the transmitter 100 constructs an OAM frame based on the administration data of the local node and transmits the frame to the transmitter 400.

In other words, as illustrated in FIG. 12B, the transmitter 100 transmits an OAM frame configured with “MEGID=000A, MEPID (local node)=1, MEPID (expected value)=2, Auto Flag=1” to the transmitter 400. Herein, subsequent processing is executed similarly to the processed described in the second embodiment.

[Operations of Process During a Fault Conducted by Transmitter in Accordance with Third Embodiment]

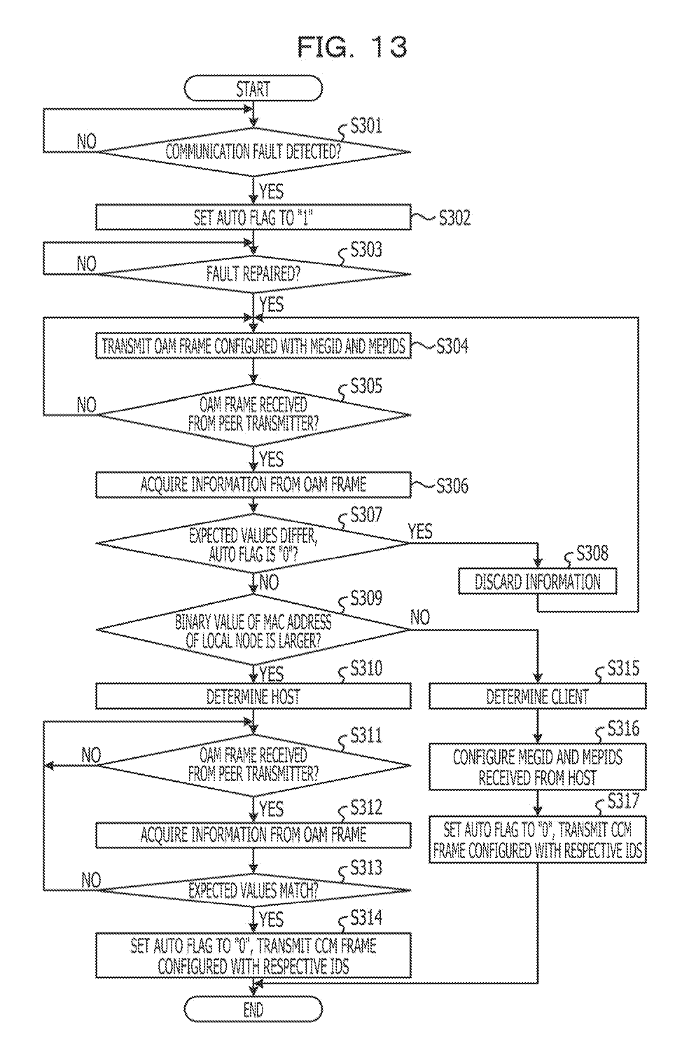

Next, operations of a process during a fault conducted by a transmitter in accordance with a third embodiment will be described. FIG. 13 illustrates operations of a process during a fault conducted by a transmitter in accordance with a third embodiment. Herein, since operations S305 to S317 illustrated in FIG. 13 are similar to operations S204 to S216 illustrated in FIG. 10, detailed description thereof is omitted or reduced.

As illustrated in FIG. 13, in a transmitter in accordance with a third embodiment, if a communication fault is detected (S301, Yes), the OAM administration unit 155 sets the Auto Flag to “1” (S302). More specifically, the OAM administration unit 155 sets the Auto Flag to “1” if a communication fault is detected by the fault monitor 156. The fault monitor 156 determines whether or not the fault has been repaired (S303).

At this point, in the case where it is determined that the fault has been repaired (S303, Yes), the OAM administration unit 155 causes an OAM frame configured with a MEGID and MEPIDs stored by the administration data storage 141 to be constructed and transmitted (S304). After OAM frames are sent and received with a transmitter peered with the transmitter in accordance with a third embodiment and the local node is determined to be a host or a client, a MEGID and MEPIDs are configured, and the sending and receiving of CCM frames is resumed (S305 to S317). Herein, a transmitter in accordance with a third embodiment does not execute the process during a fault until a communication fault is detected (S301, No).

[Operations of Process During Apparatus Replacement Conducted by Transmitter in Accordance with Third Embodiment]

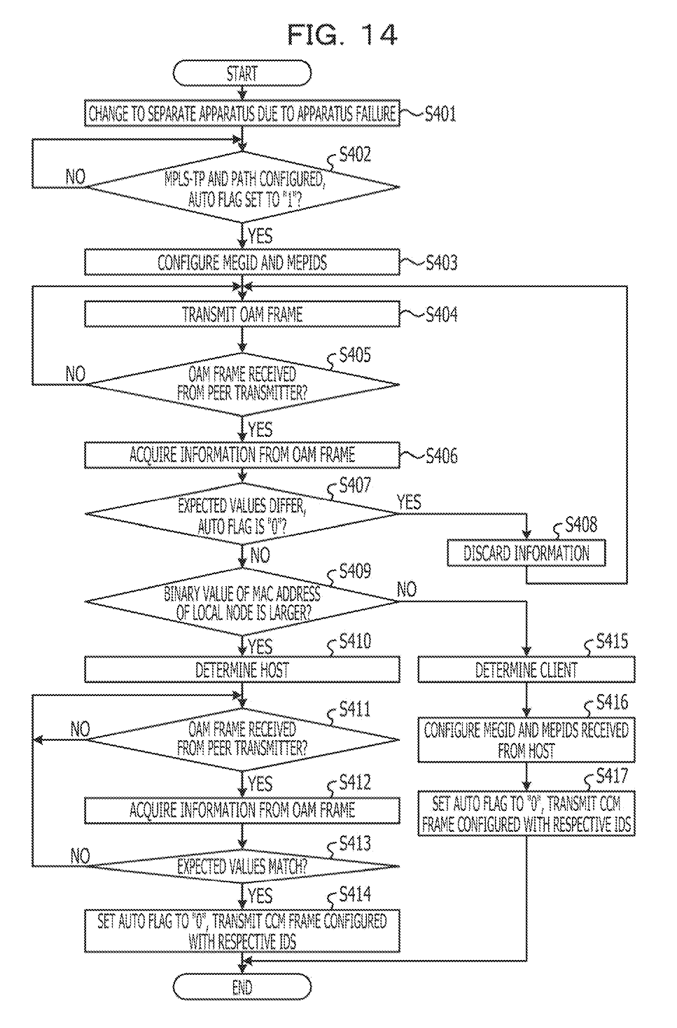

Next, operations of a process during an apparatus replacement conducted by a transmitter in accordance with a third embodiment will be described. FIG. 14 illustrates operations of a process during an apparatus replacement conducted by a transmitter in accordance with a third embodiment. Herein, since S404 to S417 illustrated in FIG. 14 are similar to S203 to S216 illustrated in FIG. 10, detailed description thereof is omitted or reduced.

As illustrated in FIG. 14, first, an administrator changes to another apparatus due to an apparatus fault (S401). After that, if MPLS-TP and a path are configured and the Auto Flag is set to “1” in an transmitter in accordance with a third embodiment (S402, Yes), the OAM administration unit 155 configures a MEGID and MEPIDs (S403). The OAM inserter 152 inserts an OAM frame constructed by the OAM frame configuring unit 151, and transmits the frame to a peer node (S404).

Subsequently, after a transmitter in accordance with a third embodiment sends and receives OAM frames with a peer transmitter and determines whether the local node is a host or a client, a MEGID and MEPIDs are configured, and the sending and receiving of CCM frames is resumed (S405 to S417).

### Advantages of Third Embodiment

As described above, according to a third embodiment, a transmitter in accordance with a third embodiment is able to autonomously re-configure a MEGID and MEPIDs even in the case where a fault occurs on the network, and makes it possible to rapidly accommodate faults.

According to a third embodiment, administrator time and effort is saved even in the case of replacing a transmitter, thus making it possible to reduce the burden of operational configuration imposed on the administrator.

### Fourth Embodiment

The foregoing thus describes first through third embodiments, but various different embodiments other than the above-described first through third embodiments are also possible. Thus, various different embodiments will be categorized into (1) to (4) and described hereinafter.

(1) Host Determination

The second and third embodiments above are described for the case where the transmitter with the greater binary value of its MAC address is determined to be the host. However, the present embodiment is not limited thereto, and the transmitter with the lesser binary value of its MAC address may be determined to be the host, for example.

(2) Apparatus Replacement

The third embodiment above is described for the case where apparatus replacement is conducted due to a failure occurring in an apparatus. However, the present embodiment is not limited thereto, and an apparatus may be replaced in order to improve transmitter performance, for example.

(3) System Configuration, Etc.

It should also be appreciated that the respective elements in the respective apparatus illustrated herein are functionally schematic elements, and are not required to be physically similar to the elements illustrated in the drawings. In other words, the specific configuration in which respective apparatus are separated or integrated is not limited to that illustrated in the drawings, and all or part thereof may be functionally or physically separated or integrated in arbitrary units according to factors such as various load and usage conditions. For example, the OAM frame configuring unit 151 and the OAM inserter 152 illustrated in FIG. 3 may also be integrated as a single processing unit. In contrast, the OAM administration unit 155 illustrated in FIG. 3 may also be separated into a comparing unit that compares MAC addresses and a determining unit that determines host or client.

(4) Control Information Configuration Program

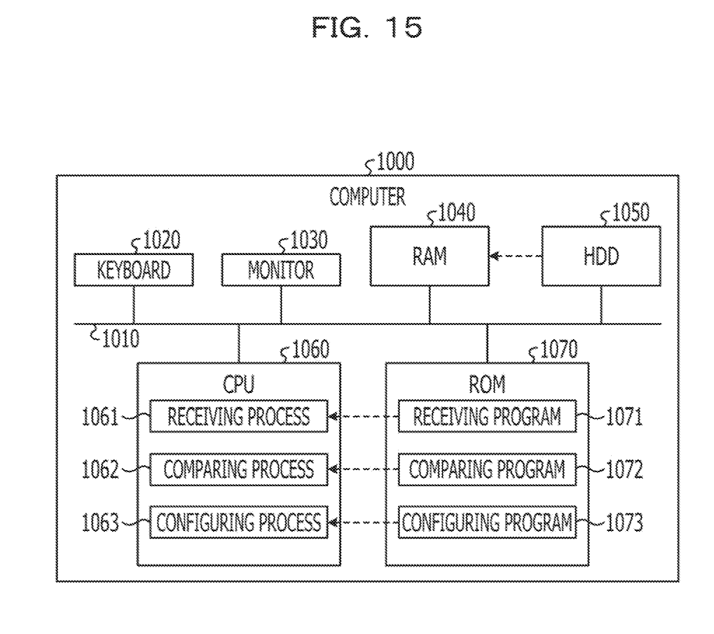

Meanwhile, although the first embodiment above was described for the case of realizing various processes by hardware logic, the present embodiment is not limited thereto, and may also be configured such that a program prepared in advance is executed on a computer. Thus, hereinafter, FIG. 15 will be used to describe an example computer that executes a control information configuration program having functions similar to those of the transmitter 1 illustrated in the first embodiment above. FIG. 15 illustrates a computer that executes a control information configuration program.

As illustrated in FIG. 15, a computer 1000 given as an information processing apparatus includes a keyboard 1020, a monitor 1030, RAM 1040, an HDD 1050, a CPU 1060, and ROM 1070. The keyboard 1020, the monitor 1030, the RAM 1040, the HDD 1050, the CPU 1060, and the ROM 1070 are coupled by a bus 1010.

A control information configuration program exhibiting functions similar to those of the transmitter 1 illustrated in the first embodiment above is stored in advance in the ROM 1070. In other words, a receiving program 1071 and a comparing program 1072 are stored in advance, as illustrated in FIG. 15. In addition, a configuring program 1073 is stored in advance in the ROM 1070. Herein, these programs 1071 to 1073 may also be integrated or separated as appropriate, similarly to the respective elements of the transmitter 1 illustrated in FIG. 1.

The CPU 1060 functions as respective processes by reading out and executing these programs 1071 to 1073 from the ROM 1070, as illustrated in FIG. 15. In other words, the CPU 1060 functions as a receiving process 1061, a comparing process 1062, and a configuring process 1063. Herein, the processes 1061 to 1063 respectively correspond to the frame receiving unit 2, the comparing unit 3, and the information configuring unit 4 illustrated in FIG. 1.

It should be appreciated that the respective programs 1071 to 1073 above are not required to be originally stored in the ROM 1070. The respective programs may be stored on another storage medium or storage apparatus, and the computer 1000 may be configured to read out and execute the respective programs therefrom. The other storage medium or storage apparatus may be a portable physical medium such as a flexible disk (FD), CD-ROM, DVD disc, magneto-optical (MO) disc, or IC card inserted into the computer 1000, for example. Alternatively, the other storage medium or storage apparatus may be a stationary physical medium such as an HDD provided internally or externally to the computer 1000. Alternatively, the other storage medium or storage apparatus may be another computer (or server) coupled to the computer 1000 via a public circuit, the Internet, a LAN, a WAN, etc.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A transmitter comprising:
a receiving unit to receive apparatus identification information that identifies transmitter and path identification information that identifies a data transfer path from another transmitter coupled to a local apparatus;
a comparing unit to compare a value indicating an address assigned to the another transmitter to a value indicating an address assigned to the local apparatus; and
a configuring unit to configure the local apparatus with apparatus identification information and path identification information determined by the local apparatus, or apparatus identification information and path identification information included in a frame received by the receiving unit, based on comparison results by the comparing unit.

2. The transmitter according to claim 1, wherein
the comparing unit compares values indicating Media Access Control (MAC) addresses as the addresses respectively assigned to the local apparatus and the another transmitter, and
the configuring unit configures the local apparatus with apparatus identification information and path identification information determined by the local apparatus when a value indicating a MAC address of the local apparatus is greater than a value indicating a MAC address of the another transmitter, and configures the local apparatus with apparatus identification information and path identification information included in a frame received by the receiving unit when a value indicating a MAC address of the local apparatus is less than a value indicating a MAC address of the another transmitter.

3. The transmitter according to claim 1, further comprising:
a transmitting unit configured to transmit a configuration request to the another transmitter when the local apparatus is configured by the configuring unit with apparatus identification information and path identification information determined by the local apparatus; wherein
the receiving unit receives a response to the configuration request transmitted by the transmitting unit from the another transmitter.

4. The transmitter according to claim 3, further comprising:
a configuration request receiving unit configured to receive the configuration request; wherein
the configuring unit, obeying a configuration request received by the configuration request receiving unit, configures the local apparatus with apparatus identification information and path identification information included in a frame received by the receiving unit, and
the transmitting unit transmits a response indicating that configuration is complete to the another transmitter when apparatus identification information and path identification information is configured by the configuring unit.

5. A control information configuration method executed by a transmitter, comprising:
receiving a frame including apparatus identification information that identifies transmitter and path identification information that identifies a data transfer path from another transmitter coupled to a local apparatus;
comparing a value indicating an address assigned to the another transmitter to a value indicating an address assigned to the local apparatus; and
configuring the local apparatus with apparatus identification information and path identification information determined by the local apparatus, or apparatus identification information and path identification information included in a frame received by the receiving operation, based on comparison results given by the comparing operation.
